(19) United States
(12) Patent Application Publication
(10) Pub. No.: US 2016/0164941 A1
(43) Pub. Date: Jun. 9, 2016

(54) METHOD FOR TRANSCODING MUTIMEDIA, AND CLOUD MULIMEDIA TRANSCODING SYSTEM OPERATING THE SAME

(71) Applicant: KONKUK UNIVERSITY INDUSTRIAL COOPERATION CORP., Seoul (KR)

(72) Inventors: Myoung Jin KIM, Seoul (KR); Yun CUI, Seoul (KR); Han Ku LEE, Seoul (KR); Seung Ho HAN, Cheonan-si (KR)

(21) Appl. No.: 14/567,957

(22) Filed: Dec. 11, 2014

(30) Foreign Application Priority Data
Dec. 5, 2014 (KR) 10-2014-0173738

(51) Int. Cl. H04L 29/06

(52) U.S. Cl. CPC H04L 65/605; H04L 65/80; H04L 65/4069

(57) ABSTRACT

Provided is a multimedia transcoding method and a cloud multimedia transcoding system (CMTS) for performing the method, wherein the method includes receiving video data, generating video blocks by dividing the video data, and transcoding the video blocks, and the receiving, the generating, and the transcoding are performed by a transcoding module.

### CROSS-REFERENCE TO RELATED APPLICATION

This application claims the priority benefit of Korean Patent Application No. 10-2014-0173738, filed on Dec. 5, 2014, in the Korean Intellectual Property Office, the disclosure of which is incorporated herein by reference.

### BACKGROUND

1. Field of the Invention

Embodiments of the present invention relate to a multimedia transcoding method and a cloud multimedia transcoding system (CMTS) for performing the method.

2. Description of the Related Art

With development of Internet technology and propagation of heterogeneous smart devices, numerous users generate and share social media using a social networking service (SNS) such as Twitter, Facebook, YouTube, Vimeo and the like without restrictions on time and location. In particular, a large amount of visual contents including texts, images, and videos is generated and shared in recent years.

Recently, a significance of technology related to an N-Screen and Multi-Screen-based video streaming service is increasing based on the propagation of heterogeneous smart devices. Diversified types of heterogeneous smart devices may provide various performance and resolution levels, and support various types of video formats. Thus, to provide a video streaming service, a file may need to be converted into a form available for streaming. However, video conversion may use a large amount of system resources. In a recent trend, a high specification device may generate video contents providing a high resolution and a high image quality, which may lead to an increase in a data amount of the video contents. Accordingly, a load placed on an information technology (IT) infrastructure may also increase due to an increasing number of video conversions necessary for the streaming.

The video conversion jobs may be performed using a large amount of system resources and thus, costs for high performance hardware may increase in an environment of the IT infrastructure. To solve this, research is being conducted on a method of gaining access through a distributed environment by using common hardware affordable with a lower cost. In general methods of gaining access through a distributed environment, a video may be converted by increasing the number of cluster machines. However, in such methods, the number of cluster machines may need to increase to provide an improved performance according to an increase in an amount of video files to be converted. In particular, due to an absence of an automated recover policy, a system may not quickly recover from an erroneous state and thus, reliability of the system may not be guaranteed.

### SUMMARY

According to an aspect of the present invention, there is provided a multimedia transcoding method including receiving video data, generating video blocks by dividing the video data, and transcoding the video blocks, wherein the receiving, the generating, and the transcoding are performed by a transcoding module.

The generating may include generating the video blocks by dividing the video data using a map function based on a size of a block for each node in a Hadoop distributed file system (HDFS).

The transcoding may include transcoding the video blocks using a map function.

The multimedia transcoding method may further include merging the transcoded video blocks, and streaming the merged video blocks.

The multimedia transcoding method may further include storing the video data in an HDFS.

The multimedia transcoding method may further include storing the video blocks in a temporary folder of the HDFS.

According to another aspect of the present invention, there is also provided a multimedia transcoding system including a web interface to receive video data, and a transcoding module to generate video blocks by dividing the video data, and transcoded the video blocks.

The transcoding module may generate the video blocks by dividing the video data using a first map function based on a size of a block for each node in an HDFS.

The transcoding module may transcode the video blocks using a second map function.

The transcoding module may merge the transcode video blocks and stream the merged video blocks.

The multimedia transcoding system may further include an HDFS to store the video data.

The transcoding module may store the video blocks in a temporary folder of the HDFS.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates an example of a Hadoop distributed file system (HDFS);

FIG. 2 illustrates an example of Hadoop MapReduce;

FIG. 3 illustrates an example of operations of multiple MapReduce;

FIG. 4 illustrates an example of a cloud multimedia transcoding system (CMTS);

FIG. 5 illustrates another example of a CMTS;

FIG. 6 illustrates an example of operating the CMTS of FIG. 5;

FIG. 7 illustrates an example of a data flow in a transcoding module of FIG. 6; and

FIGS. 8 through 14 illustrate examples of classes for implementing the transcoding module of FIG. 7.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

It should be understood, however, that there is no intent to limit this disclosure to the particular example embodiments disclosed. On the contrary, example embodiments are to cover all modifications, equivalents, and alternatives falling within the scope of the example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of this disclosure. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be described in detail with reference to the accompanying drawings.

In the present disclosure, a module may be hardware that may perform a function and an operation for each name explained in the specification, a computer program code that may perform predetermined function and operation, or an electronic recordable medium, for example, a processor and a microprocessor, including a computer program code for performing predetermined function and operation.

Accordingly, the module may indicate a functional and/or structural combination of hardware for performing technical ideas of the present disclosure and/or software for driving the hardware.

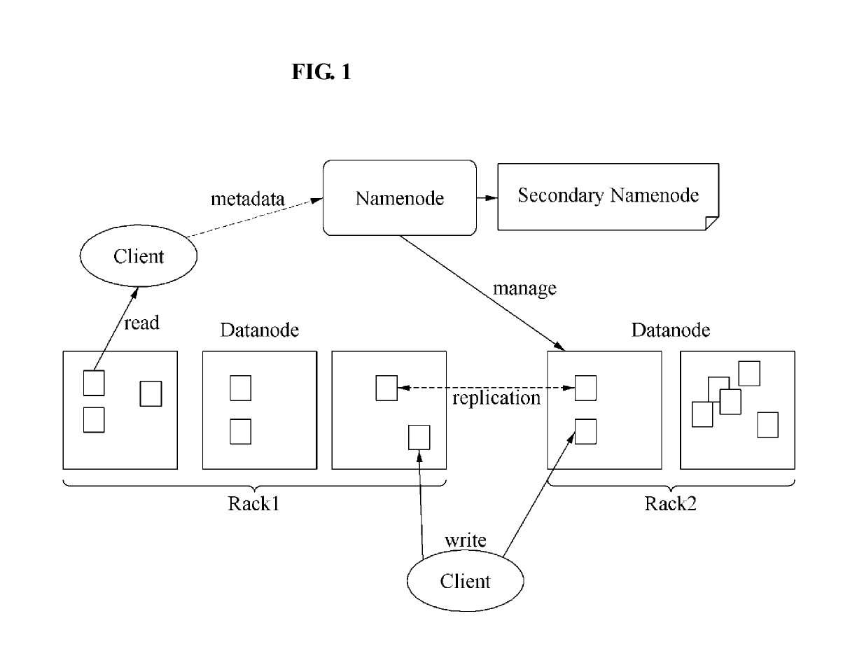

FIG. 1 illustrates an example of a Hadoop distributed file system (HDFS).

Referring to FIG. 1, the HDFS may be an operable file-system written in Java for a Hadoop framework, and may be an open-source implementation in a Google file system (GFS). The HDFS may be formed in a master/slave structure. Also a master node may also be referred to as a name node, and a slave node may also be referred to as a data node.

The HDFS may divide a single file into a plurality of blocks, and store the divided nodes in a plurality of data nodes. In the HDFS, files, directories, and blocks may be managed by the name node. For example, the single file may be divided into a plurality of blocks based on a unit of 64 megabytes (MB), and each of the divided blocks may be replicated to generate replication blocks. A number of replication blocks may be changed through a setting of a user. The replication blocks may include the divided blocks.

The HDFS may store each of the generated blocks in a different data node. Since the HDFS is recovered from a system error using another replication block, the HDFS may maintain reliability thereof.

The HDFS may be mounted on a Linux file system using Mountable HDFS, for example, a fuse-dfs.

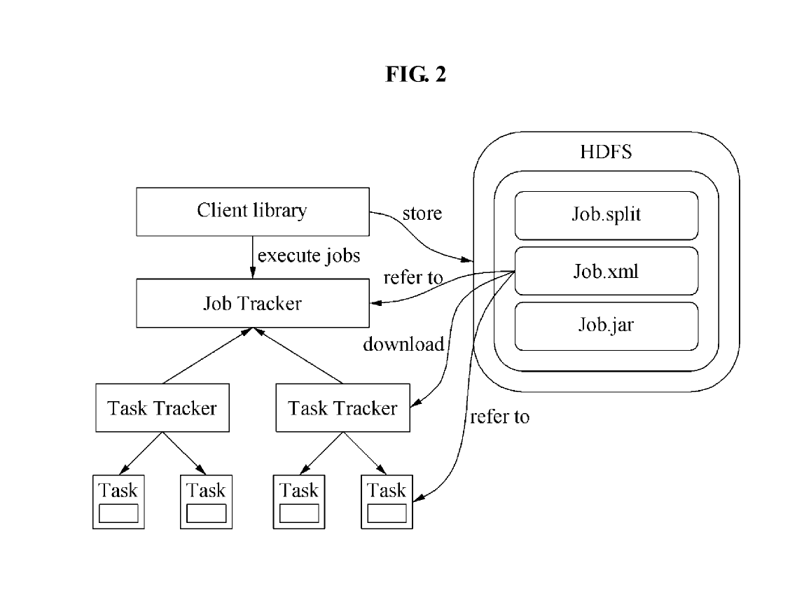

FIG. 2 illustrates a configuration of Hadoop MapReduce.

Referring to FIG. 2, the Hadoop MapReduce may be a software-distributed framework provided in a master/slave structure for processing Big Data greater than one petabyte (PB).

A master of the Hadoop MapReduce may be a job tracker, and a slave of the Hadoop MapReduce may be a task tracker. The job tracker may execute and manage a job requested from a user, and an actual job may be executed in each task tracker.

Each task tracker may perform a distributed parallel processing on a block distributed to each node of an HDFS in response to a user request or a job request.

The Hadoop MapReduce may be operated based on the HDFS. Thus, a node of the Hadoop MapReduce may be extended in response to a performance request. In response to the extended node, performance of the Hadoop MapReduce may be correspondingly improved.

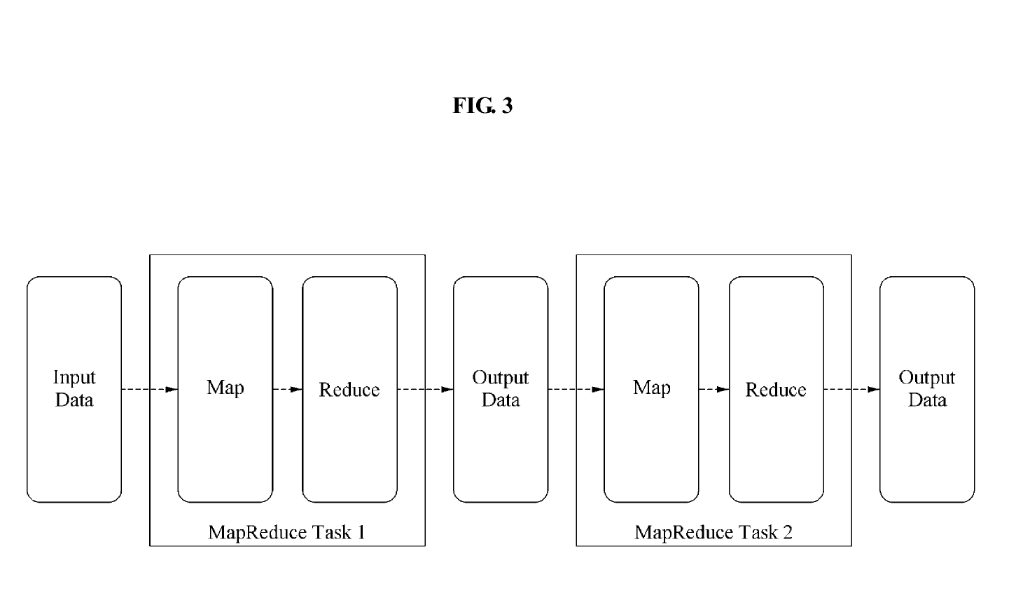

FIG. 3 illustrates an example of an operation of multiple MapReduce (jobs).

Referring to FIG. 3, a MapReduce job may include a map operation and a reduce operation. Also, the MapReduce job may include only the map operation in response to a user request. In the present disclosure, the map operation and the reduce operation may be defined into a job.

Hadoop MapReduce may analyze a large amount of video data. When the analyzed video data is to be reanalyzed or reprocessed based on a purpose or a program logic of the user, the analyzed video data may be processed through the multiple MapReduce jobs.

Three methods may be used to configure the multiple MapReduce jobs based on the purpose or the program logic of the user.

In one method, the map operation and the reduce operation may be sequentially connected using a class JobConf in a MapReduce program.

In another method, the multiple MapReduce jobs may be defined using a class ChainMapper.

In still another method, the job may be performed by defining a MapReduce job using the class JobConf and setting a dependency relationship of each job using a class JobControl.

Whether an intermediate result value is generated may be a significant difference occurring in a process of configuring the multiple MapReduce.

In the method using the JobConf and the method using the JobControl, the intermediate result value may be stored in the HDFS. In the method using the ChainMapper, a separate intermediate result value may not be generated in the HDFS, and the job may be continuously performed in a corresponding job node.

In the present disclosure, the multiple MapReduce may be implemented using one of the three aforementioned methods. Hereinafter, for increased clarity and conciseness, the following descriptions will be provided based on a case in which the multiple MapReduce is implemented based on the method using the JobControl.

Since the descriptions provided with reference to FIGS. 1 through 2 are also applicable here, repeated descriptions will be omitted for increased clarity and conciseness.

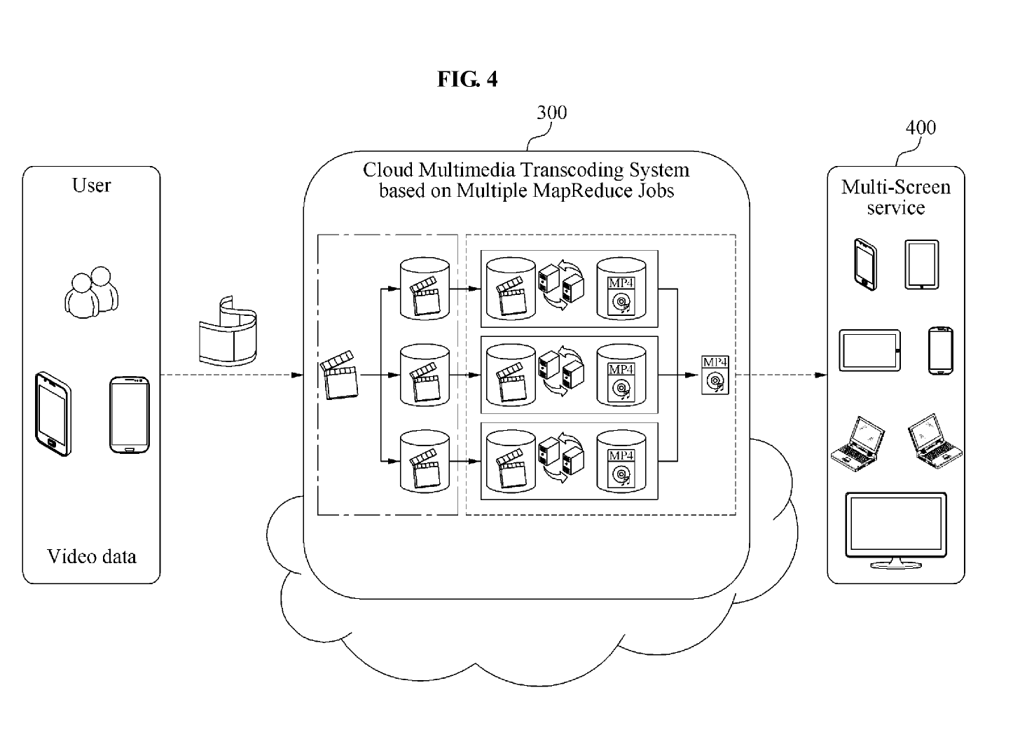

FIG. 4 illustrates a configuration of a cloud multimedia transcoding system (CMTS) 300.

Referring to FIG. 4, the CMTS 300 may be a multiple MapReduce Jobs-based CMTS.

The CMTS 300 may be a system for converting video data into data appropriate for streaming in order to be provided to a terminal apparatus 400. For example, the video data may be data generated from a heterogeneous smart device of a user. The terminal apparatus 400 may be a heterogeneous smart device differing from the heterogeneous smart device of the user.

The CMTS 300 may use a multiple-MapReduce structure. For example, the multiple-MapReduce structure may be provided as illustrated in FIG. 3.

The CMTS 300 may generate a plurality of video blocks by dividing the video data based on a size of a block for each node included in an HDFS.

The CMTS 300 may convert the plurality of video blocks. For example, the CMTS 300 may transcode the plurality of video blocks.

The CMTS 300 may merge the transcoded video blocks. For example, the CMTS 300 may merge the transcoded video blocks through a reduce operation. The merged video blocks may be provided to the terminal apparatus 400.

The CMTS 300 may perform a separate dividing and merging operation on a video block based on characteristics of the video data between video conversion jobs. In this example, since the CMTS 300 meaningfully divides each of the video blocks by applying a multiple MapReduce-based video conversion method, an entire block may not be used during the video conversion jobs. Other than a first block of the video blocks, remaining blocks may be meaningless data. By using MkvtoolNix, each of the video blocks may be divided to be meaningful.

Through this, a processing of redundant data may not be performed, thereby solving an issue of increasing a processing time according to an increase in the video frames. In contrast to a general system, an absence of the processing of redundant data may allow video data exceeding a predetermined amount to be converted by using a normal java virtual machine (JVM) heap memory.

Since the descriptions provided with reference to FIGS. 1 through 3 are also applicable here, repeated descriptions will be omitted for increased clarity and conciseness.

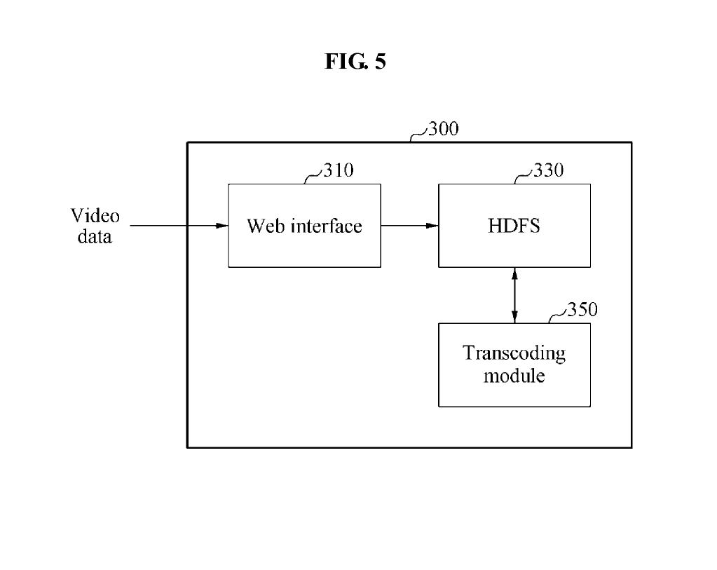

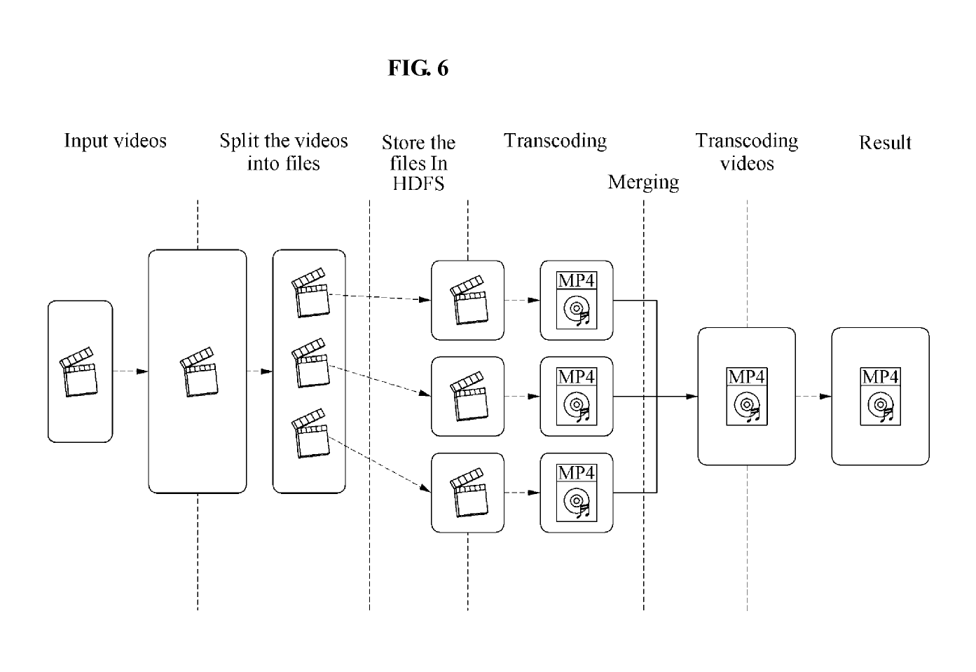

FIG. 5 illustrates another example of a CMTS, and FIG. 6 illustrates an operation method of the CMTS of FIG. 5.

Referring to FIGS. 5 and 6, the CMTS 300 includes a web interface 310, an HDFS 330, and a transcoding module 350.

The web interface 310 may receive video data, and store the received video data in the HDFS 330.

The transcoding module 350 may generate video blocks by dividing the video data stored in the HDFS 330 using a first map, for example, a first map function and a first map operation, based on a size of a block for each node in the HDFS 330. For example, the transcoding module 350 may divide, for example, split the video data stored in the HDFS 330 using the first map function based on the size of the block for each node included in the HDFS 330. In this example, the video data may be divided into video blocks based on a meaningful unit.

The transcoding module 350 may store the generated video blocks in a temporary folder of the HDFS 330.

The transcoding module 350 may perform a video conversion on the video blocks. For example, the transcoding module 350 may transcode the video blocks. As an example, the transcoding module 350 may perform a transcoding on the video blocks using a second map, for example, a second map function. The second map function may be, for example, a video map task. Accordingly, the transcoding module 350 may perform a distributed parallel processing on the video blocks to be in a form appropriated for streaming, for example, a defined size and format.

The transcoding module 350 may merge the transcoded video blocks. For example, the transcoding module 350 may merge the transcoded video blocks through a reduction operation. Thus, the transcoding module 350 may perform the reduce operation to merge the video blocks in identical video data.

The merged video blocks, for example, converted video data may be provided to the terminal apparatus 400 based on a streaming service. For example, the converted video data may be stored in the HDFS 330, and provided, to the terminal apparatus 400, through Mountable HDFS based on the streaming service or based on a download service as a file.

Example embodiments may provide technology for performing a separate dividing and merging operation on a video block based on characteristics of video data between video converting jobs.

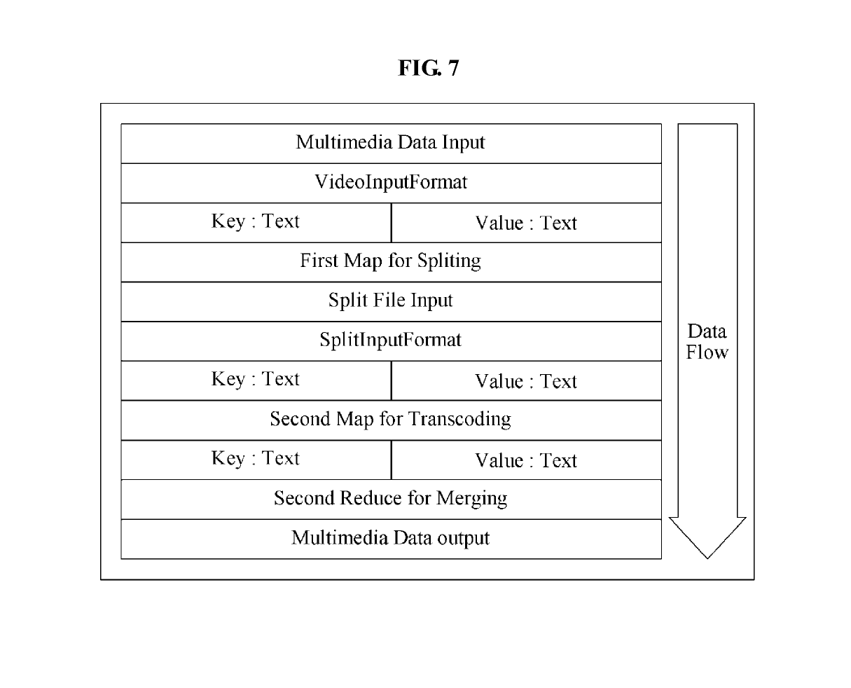

FIG. 7 illustrates an example of a data flow in a transcoding module of FIG. 6.

Referring to FIGS. 5 through 7, the transcoding module 350 may configure multiple MapReduce jobs using Hadoop JobControl. In this example, MkvToolNix may be used for a dividing operation, for example, a first map operation, and a merging operation, for example, a reduce operation. Also, a Xuggler media library may be used for a converting operation, for example, a second map operation and a transcoding operation.

The multiple MapReduce jobs may include a dual map operation and the reduce operation.

The multiple MapReduce job may be implemented using the JobControl of a class VideoConversion. Between two operations, an input/output of a Key and a Value may be implemented using VideoInputFormat, VideoRecordReader, SplitInputFormat, and SpiltRecodeReader. A result of a job performed in each TaskTracker may be transmitted to the HDFS 330 based on a copyFromLocal( ) method of Hadoop FileSystem. Thus, the transcoding module 350 may not implement a class to output data to the HDFS 330 separately.

The dividing operation, for example, the first map operation of the transcoding module 350 may be performed using classes FirstMap and Spliter. The converting operation, for example, the second map operation, of the transcoding module 350 may be performed using classes SecondMap, Transcoder, Data, SecondMapPartitioner, SecondReduce, and SecondMerger.

The transcoding module 350 may have a data flow described below.

First, a class VideoInputFormat may be used to transfer, to a first map, the Key corresponding to a Text format of original video data and including an original file name, and the Value corresponding to the Text format and including a position of the HDFS 330 in the original file.

Second, the video data stored in the HDFS 330 may be divided based on the size of the block included in the HDFS 330 using the transferred Key and Value. The divided video data may be transmitted to a temporary folder of the HDFS 330 based on a FileSystem class copyFromLocal method.

Third, the divided video data may be transferred to a second map through a class SplitInputFormat. In this example, the transferred Key may be used as a file name of video data divided as a Text format, and the Value may be transferred to a bytestream of video data divided as a format BytesWritables.

Fourth, the divided video data may be converted into a video format defined by the user based on the transferred Key and Value.

The converted video data may be transferred to a reducer through a partitioner. In this example, since an identical type of data or file is allowed to be merged through the partitioner, the transferred Key may be used as the name of the original file corresponding to the format Text. The value may be transmitted by converting a Data object corresponding to the format BytesWritables into a bytes array. In this example, a value to be input in the Data object may be a file name of the converted data and a bytestream of the converted video data.

Subsequently, the converted video data may be merged using the Value and the Key transferred through the partitioner so as to be transmitted to a result folder of the HDFS 330.

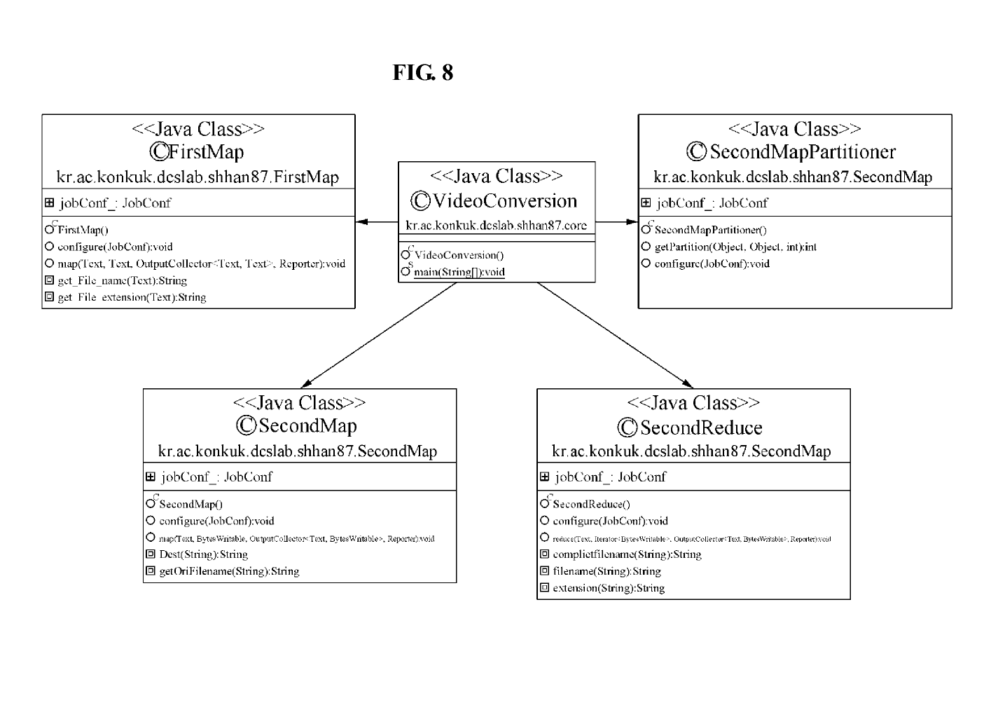

Hereinafter, related descriptions with respect to classes for implementing the transcoding module of FIG. 7 will be provided with reference to FIGS. 8 through 14.

FIG. 8 is a diagram illustrating a class VideoConversion.

Referring to FIG. 8, the class VideoConversion may be a class to designate a function for each job of a task tracker in response to an initial job submitted to a job tracker. A size, a format, and the like set for video data input from a user may be defined using a class Configuration.

Multiple MapReduce jobs may be defined using JobControl. In this example, the multiple MapReduce jobs may be defined and a dependency relationship between the multiple MapReduce jobs may be set. Subsequently, the multiple MapReduce jobs may be performed using the task tracker.

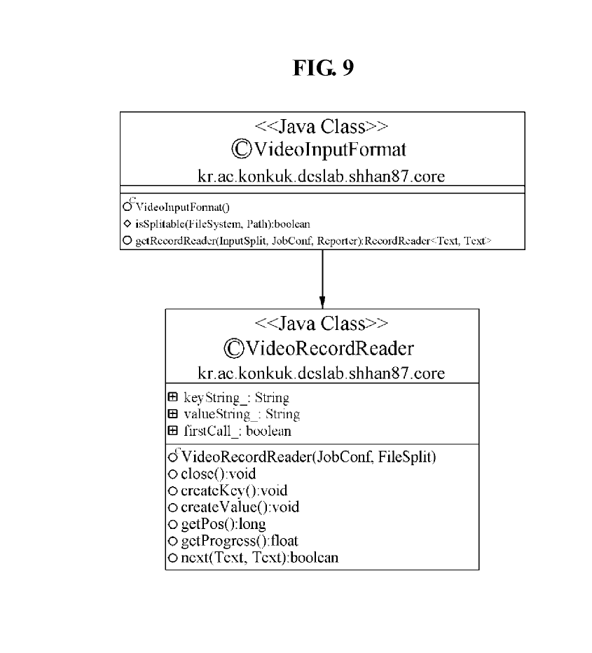

FIG. 9 is a diagram illustrating classes VideoInputFormat and VideoRecordReader.

Referring to FIG. 9, the classes VideoInputFormat and VideoRecordReader may perform a function to designate Key and Value such that a video file is processed in a Hadoop MapReduce. VideoInputFormat may extract an address value of an HDFS for an original video of a video converted into a map through VideoRecordReader, and transfer a video file name and an address value of the HDFS for the original video to the Key and the Value, respectively.

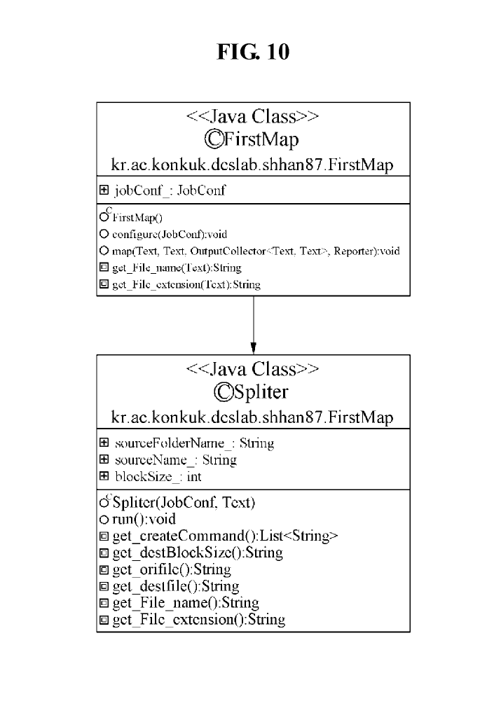

FIG. 10 is a diagram illustrating classes FirstMap and Spliter.

Referring to FIG. 10, a function to divide an original image based on a size of a block currently set in an HDFS may be performed in a first map.

A map operation may be defined in FirstMap, and an actual job may be performed by calling a process of MkvToolnix from each task tracker using the class Spliter and executing a dividing job. Among blocks obtained by dividing a video using the HDFS, blocks other than a first block may not have a Header value of the video and thus, may be recognized as a file that is incapable of being played back. Since the blocks are recognized as an abnormal file during a conversion job, Spliter may be used to divide the video separately.

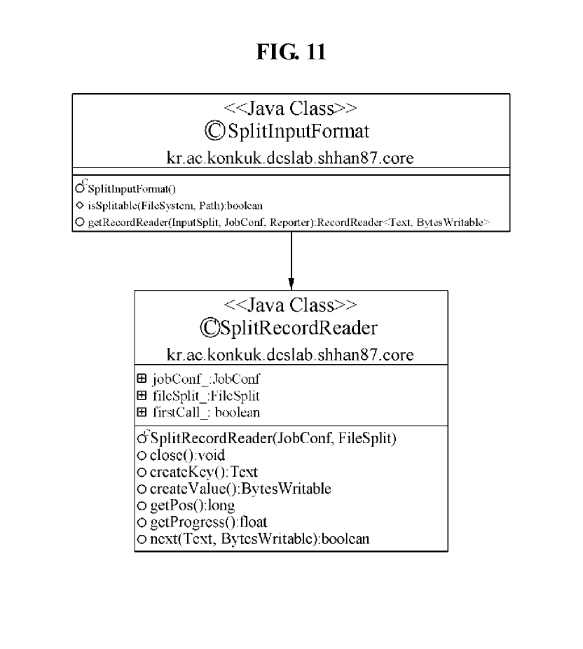

FIG. 11 is a diagram illustrating classes SplitInputFormat and SplitRecordReader.

Referring to FIG. 11, the classes SplitInputFormat and SplitRecordReader may perform a function to read a video divided in a first map operation, into Key and Value for a second map operation. Since the Key and Value has a different data type based on a map operation, InputFormat may be defined for each job separately. SplitInputFormat may read the video divided in the first map operation, into a bytestream using SplitRecordReader such that the Key including a name of the divided video and the Value including the bytestream of the divided video are transferred to a second map.

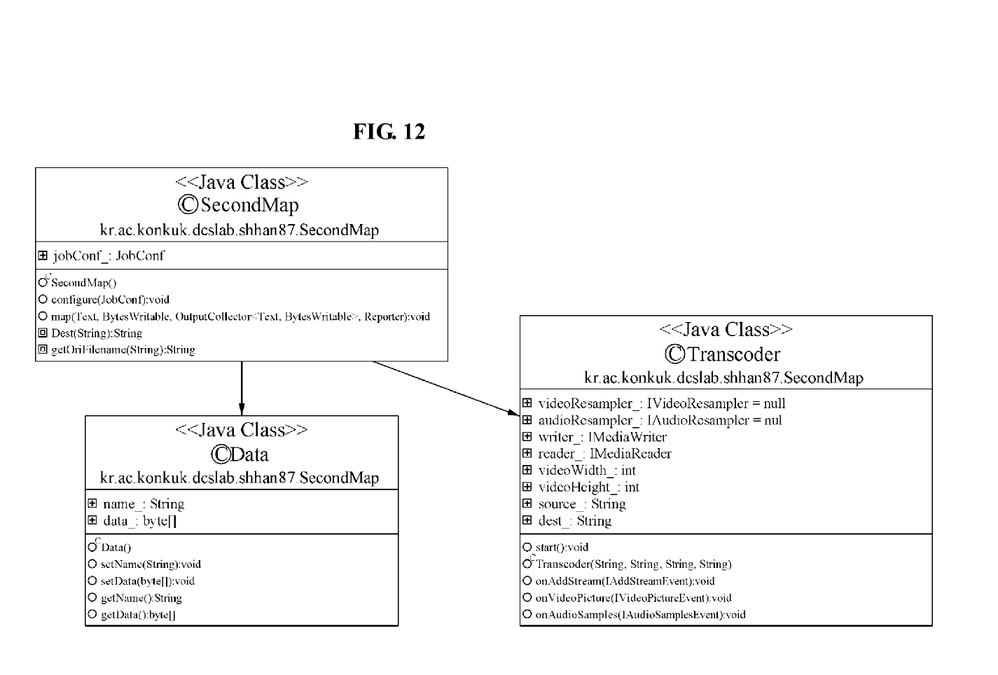

FIG. 12 is a diagram illustrating classes SecondMap, Transcoder, and Data.

Referring to FIG. 12, an actual transcoding job may be performed in the class Transcoder. Data on which a conversion is completed may be transferred to Reduce. In this example, the data may be transferred as Key storing a file name of a video converted using an object included in the class Data, and Value storing a bytestream of the converted video.

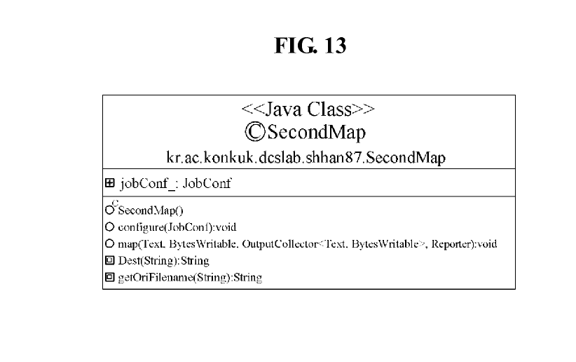

FIG. 13 is a diagram illustrating a class SecondMapPartitioner.

Referring to FIG. 13, in a process of converting a video through a second map operation, a sequential mergence using an identical video file may need to be performed to obtain a single video. In this example, a partitioner may perform a function to transfer converted video files to Reduce.

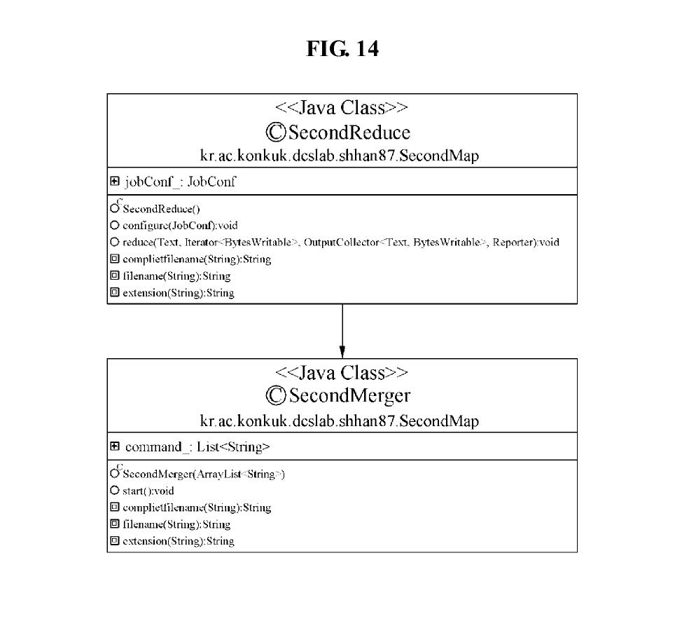

FIG. 14 is a diagram illustrating classes SecondReduce and SecondMerger class.

Referring to FIG. 14, converted video files may be merged into a single video file through the classes SecondReduce and SecondMerger.

The single merged video file may be transmitted to a result folder of an HDFS designated by a user based on copyFromLocal( ) of FileSystem.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The methods according to the above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A multimedia transcoding method comprising:
receiving video data;
generating video blocks by dividing the video data; and
transcoding the video blocks,
wherein the receiving, the generating, and the transcoding are performed by a transcoding module.

2. The method of claim 1, wherein the generating comprises generating the video blocks by dividing the video data using a map function based on a size of a block for each node in a Hadoop distributed file system (HDFS).

3. The method of claim 1, wherein the transcoding comprises transcoding the video blocks using a map function.

4. The method of claim 1, further comprising:
merging the transcoded video blocks; and
streaming the merged video blocks.

5. The method of claim 1, further comprising:
storing the video data in an HDFS.

6. The method of claim 5, further comprising:
storing the video blocks in a temporary folder of the HDFS.

7. A multimedia transcoding system comprising:
a web interface to receive video data; and
a transcoding module to generate video blocks by dividing the video data, and transcoded the video blocks.

8. The system of claim 7, wherein the transcoding module generates the video blocks by dividing the video data using a first map function based on a size of a block for each node in a Hadoop distributed file system (HDFS).

9. The system of claim 8, wherein the transcoding module transcodes the video blocks using a second map function.

10. The system of claim 7, wherein the transcoding module merges the transcode video blocks and streams the merged video blocks.

11. The system of claim 7, further comprising:
an HDFS to store the video data.

12. The system of claim 11, wherein the transcoding module stores the video blocks in a temporary folder of the HDFS.
